(19) United States
(12) Patent Application Publication
(10) Pub. No.: US 2017/0148400 A1
(43) Pub. Date: May 25, 2017

(54) LIQUID CRYSTAL DISPLAY PANEL AND LIQUID CRYSTAL DISPLAY DEVICE

(71) Applicant: Shenzhen China Star Optoelectronics Technology Co. Ltd., Shenzhen (CN)

(72) Inventors: Yinhung CHEN, Shenzhen (CN); Yuntao LI, Shenzhen (CN)

(73) Assignee: Shenzhen China Star Optoelectronics Technology Co. Ltd., Shenzhen (CN)

(21) Appl. No.: 14/779,572

(22) PCT Filed: Aug. 7, 2015
(86) PCT No.: PCT/CN2015/086330

§ 371 Date: Sep. 24, 2015

(30) Foreign Application Priority Data
Jul. 24, 2015 (CN) 201510444177.5

(51) Int. Cl. G09G 3/36

(52) U.S. Cl. CPC G09G 3/3648; G09G 3/3677; G09G 2320/0276; G09G 2310/08; G09G 2300/0426; G09G 2320/064

(57) ABSTRACT

A liquid crystal display panel and a liquid crystal display device are provided. The panel has a driving portion including a plurality of chips and a plurality of electronic components. The chips comprise a source driver chip, a pulse width modulation chip, a programmable gamma correction buffer chip, and a timing control chip. The electronic components are disposed on the printed circuit board. The source driver chip, the pulse width modulation chip, and the programmable gamma correction buffer chip are disposed on the flexible connector.

### FIELD OF THE INVENTION

The present invention relates to a technical field of displays, and in particular to a liquid crystal display panel and a liquid crystal display device.

### BACKGROUND OF THE INVENTION

A liquid crystal display panel with a common driving mode (first type driving mode) has a body portion and a driving portion. The body portion includes a plurality of data lines, a plurality of scan lines, and a plurality of pixel units defined by the data lines and the scan lines. Refer to FIG. 1, the driving portion has a printed circuit board 11 and a flexible connector 12. A programmable gamma correction buffer chip 101, a timing control chip 102, a pulse width modulation chip 103, and electronic components (such as resistors, capacitors, and inductors) are disposed on the printed circuit board 11. A source driver chip 104 is disposed on the flexible connector 12.

As compared with the liquid crystal display panel with the common driving mode, a liquid crystal display panel with a driving mode of GOA (second type driving mode) has a voltage converter chip without a gate driver chip. A voltage of clock signals is converted for transmitting to scan lines. Refer to FIG. 2, the driving portion has a printed circuit board 13 and a flexible connector 14. A programmable gamma correction buffer chip 101, a timing control chip 102, a pulse width modulation chip 103, a voltage converter chip 105, and electronic components (such as resistors, capacitors, and inductors) are disposed on the printed circuit board 13. A source driver chip 104 is disposed on the flexible connector 12.

There are many chips disposed on the printed circuit board in the first driving mode and the second driving mode, thus the size of the printed circuit board cannot be reduced. The printed circuit board may lead to high manufacturing costs, and it is difficult for the manufacture of the printed circuit board to satisfy the small size panels.

Therefore, a new a liquid crystal display panel and a new liquid crystal display device needs to be developed which can solve the problems existing in the conventional art described above.

### SUMMARY OF THE INVENTION

A primary object of the present invention is to provide a liquid crystal display panel and a liquid crystal display device, which reduces the size and the costs of the liquid crystal display panel.

To achieve the above object, the present invention provides a liquid crystal display panel which comprises a body portion and a driving portion. The body portion includes a plurality of data lines, a plurality of scan lines, and a plurality of pixel units defined by the data lines and the scan lines. The driving portion includes a printed circuit board, a flexible connector, a plurality of chips, and a plurality of electronic components disposed on the printed circuit board. The body portion electrically connects to the printed circuit board through the flexible connector, and the chips comprise a source driver chip, a pulse width modulation chip, a programmable gamma correction buffer chip, a timing control chip for generating clock signals, and a voltage converter chip for converting a voltage of the clock signal for transmitting to the scan lines. The source driver chip, the pulse width modulation chip, the programmable gamma correction buffer chip, and the voltage converter chip are disposed on the flexible connector to reduce a space of the driving portion.

In one embodiment of the present invention, the timing control chip has a body module disposed on the flexible connector, and a storage module is disposed on the printed circuit board.

In one embodiment of the present invention, the timing control chip is disposed on the flexible connector.

In one embodiment of the present invention, the printed circuit board is configured to provide video signals and a power source. The programmable gamma correction buffer chip is configured to modulate a pulse width of the power source from the printed circuit board. The pulse width modulation chip is configured to generate control voltage signals according the power source after modulating. The timing control chip is configured to convert the video signals into digital signals. The source driver chip is configured to generate data signals according the digital signals and the control voltage signals.

To achieve the above object, the present invention provides a liquid crystal display panel which comprises a body portion and a driving portion. The body portion includes a plurality of data lines, a plurality of scan lines, and a plurality of pixel units defined by the data lines and the scan lines. The driving portion includes a printed circuit board, a flexible connector, a plurality of chips, and a plurality of electronic components disposed on the printed circuit board. The body portion electrically connects to the printed circuit board through the flexible connector, and the chips comprise a source driver chip, a pulse width modulation chip, a programmable gamma correction buffer chip, and a timing control chip. The source driver chip, the pulse width modulation chip, and the programmable gamma correction buffer chip are disposed on the flexible connector to reduce a space of the driving portion.

In one embodiment of the present invention, the chips further comprise a voltage converter chip disposed on the flexible connector.

In one embodiment of the present invention, the timing control chip has a body module disposed on the flexible connector, and a storage module disposed on the printed circuit board.

In one embodiment of the present invention, the timing control chip is disposed on the flexible connector.

In one embodiment of the present invention, the printed circuit board is configured to provide video signals and a power source. The programmable gamma correction buffer chip is configured to modulate a pulse width of the power source from the printed circuit board. The pulse width modulation chip is configured to generate control voltage signals according the power source after modulating. The timing control chip is configured to convert the video signals to digital signals. The source driver chip is configured to generate data signals according the digital signals and the control voltage signals.

In one embodiment of the present invention, the timing control chip is configured to generate clock signals, and the voltage converter chip is configured to convert a voltage of the clock signal for transmitting to the scan lines.

To achieve the above object, the present invention provides a liquid crystal display device which comprises a backlight module and a liquid display panel. The liquid display panel includes a body portion and a driving portion. The body portion includes a plurality of data lines, a plurality of scan lines, and a plurality of pixel units defined by the data lines and the scan lines. The driving portion includes a printed circuit board, a flexible connector, a plurality of chips, and a plurality of electronic components disposed on the printed circuit board. The body portion electrically connects to the printed circuit board through the flexible connector, and the chips comprise a source driver chip, a pulse width modulation chip, a programmable gamma correction buffer chip, and a timing control chip. The source driver chip, the pulse width modulation chip, and the programmable gamma correction buffer chip are disposed on the flexible connector to reduce a space of the driving portion.

In one embodiment of the present invention, the chips further comprise a voltage converter chip disposed on the flexible connector.

In one embodiment of the present invention, the timing control chip has a body module disposed on the flexible connector, and a storage module disposed on the printed circuit board.

In one embodiment of the present invention, the timing control chip is disposed on the flexible connector.

In one embodiment of the present invention, the printed circuit board is configured to provide video signals and a power source. The programmable gamma correction buffer chip is configured to modulate a pulse width of the power source from the printed circuit board. The pulse width modulation chip is configured to generate control voltage signals according the power source after modulating. The timing control chip is configured to convert the video signals to digital signals. The source driver chip is configured to generate data signals according the digital signals and the control voltage signals.

In one embodiment of the present invention, the timing control chip is configured to generate clock signals, and the voltage converter chip is configured to convert a voltage of the clock signal for transmitting to the scan lines.

The size and the costs of the liquid crystal display panel of the present invention can be reduced by reconfiguring the chips and the electronic components.

### DESCRIPTION OF THE DRAWINGS

FIG. 1 is a schematic view of a driving portion of a first type liquid crystal display panel in the prior art;

FIG. 2 is a schematic view of a driving portion of a second type liquid crystal display panel in the prior art;

FIG. 3 is a schematic view of a first type driving portion of the first type liquid crystal display panel according to a preferred embodiment of the present invention;

FIG. 4 is a schematic view of a timing control chip according to a preferred embodiment of the present invention;

FIG. 5 is a schematic view of a second type driving portion of the first type liquid crystal display panel according to a preferred embodiment of the present invention;

FIG. 6 is a schematic view of a first type driving portion of the second type liquid crystal display panel according to a preferred embodiment of the present invention; and

FIG. 7 is a schematic view of a second type driving portion of the second type liquid crystal display panel according to a preferred embodiment of the present invention.

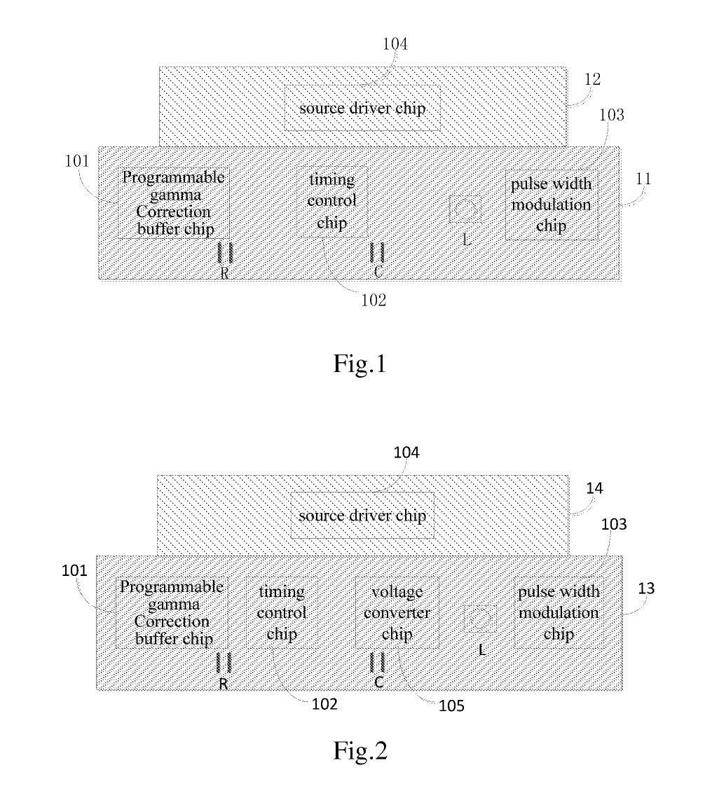

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc. are only directions by referring to the accompanying drawings, and thus the used directional terms are used to describe and understand the present invention, but the present invention is not limited thereto.

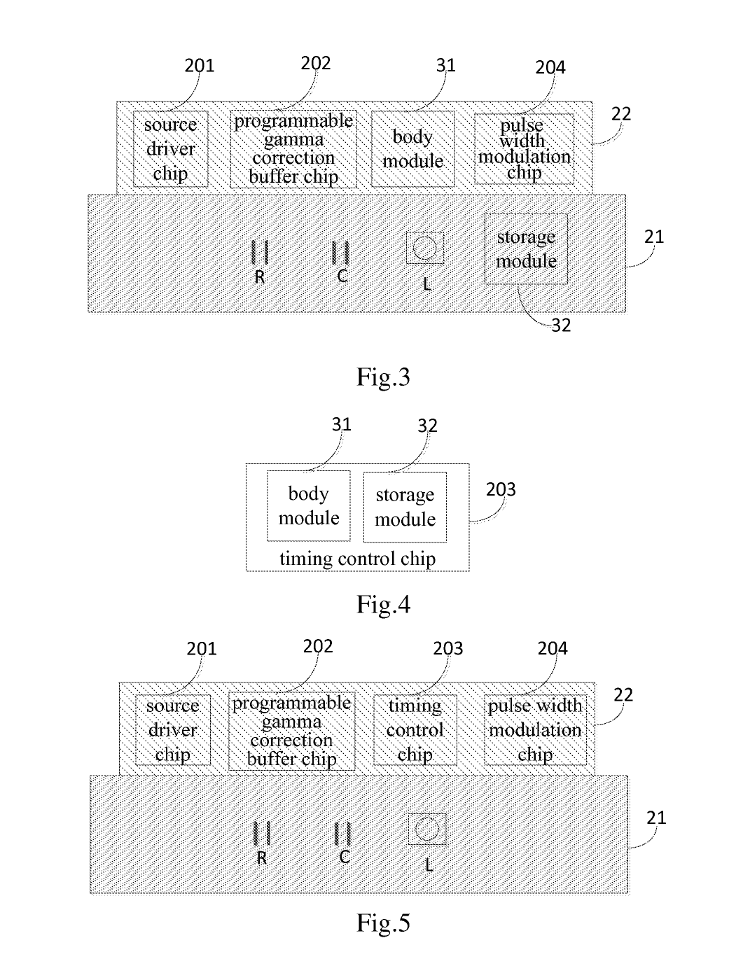

Refer to FIG. 3, which is a schematic view of a first type driving portion of the first type liquid crystal display panel according to a preferred embodiment of the present invention.

The first type liquid crystal display panel of the present invention with a common driving mode having a body portion and a driving portion. The body portion includes a plurality of data lines, a plurality of scan lines, and a plurality of pixel units defined by the data lines and the scan lines. Referring to FIGS. 3 and 4, the driving portion includes a printed circuit board 21 and a flexible connector 22. The body portion electrically connects to the printed circuit board 21 through the flexible connector 22. The driving portion includes a plurality of chips and a plurality of electronic components. The chips comprise a source driver chip 201, a pulse width modulation chip 204, a programmable gamma correction buffer chip 202, and a timing control chip 203.

The electronic components have resistors, capacitors, and inductors disposed on the printed circuit board. Due to the electronic components working unstably when disposed on the flexible connector, more specifically, the inductors are disposed on the flexible connector.

The source driver chip 201, the pulse width modulation chip 204, and the programmable gamma correction buffer chip 202 are disposed on the flexible connector to reduce a space of the driving portion.

The printed circuit board 21 is configured to provide video signals and a power source. The programmable gamma correction buffer chip 202 is configured to modulate a pulse width of the power source from the printed circuit board 21 to provide the power source to the pulse width modulation chip 204, the timing control chip 203, and the source driver chip 201. The pulse width modulation chip 204 is configured to generate control voltage signals according the power source after modulating of the pulse width modulation chip 204. The timing control chip 203 is configured to convert the video signals to digital signals and to generate clock signals. The source driver chip 201 is configured to generate data signals according the digital signals and the control voltage signals. The driving portion further includes a gate driver chip (not shown), and the gate driver chip is configured to generate scan signals according the clock signals.

In the embodiment, a body module 31 of the timing control chip 203 is disposed on the flexible connector 22, and a storage module 32 of the timing control chip 203 is disposed on the printed circuit board 21. The timing control chip 203 has the body module 31 and the storage module 32. The the storage module 32 is configured to store the programs in the timing control chip 203. The body module 31 is a hardware in the timing control chip 203.

The storage module is a core part of the timing control chip. Therefore the body module is disposed on the flexible connector, and the storage module is disposed on the printed circuit board. The work efficiency of the timing control chip can be ensured and more stable. In addition, all of the other chips are disposed on the flexible connector, and the size of the flexible connector cannot be increased. Thus, the size and the cost of the liquid crystal display panel can be reduced by reducing the space of the driving portion and the size of the printed circuit board.

Refer to FIG. 5, which is a schematic view of a second type driving portion of the first type liquid crystal display panel according to a preferred embodiment of the present invention. As compared with the first type driving portion, the difference is as follows:

Refer to FIG. 5, all of the timing control chip 203 is disposed on the flexible connector 22. Thus the size of the liquid crystal display panel can be further reduced by reducing the size of the printed circuit board.

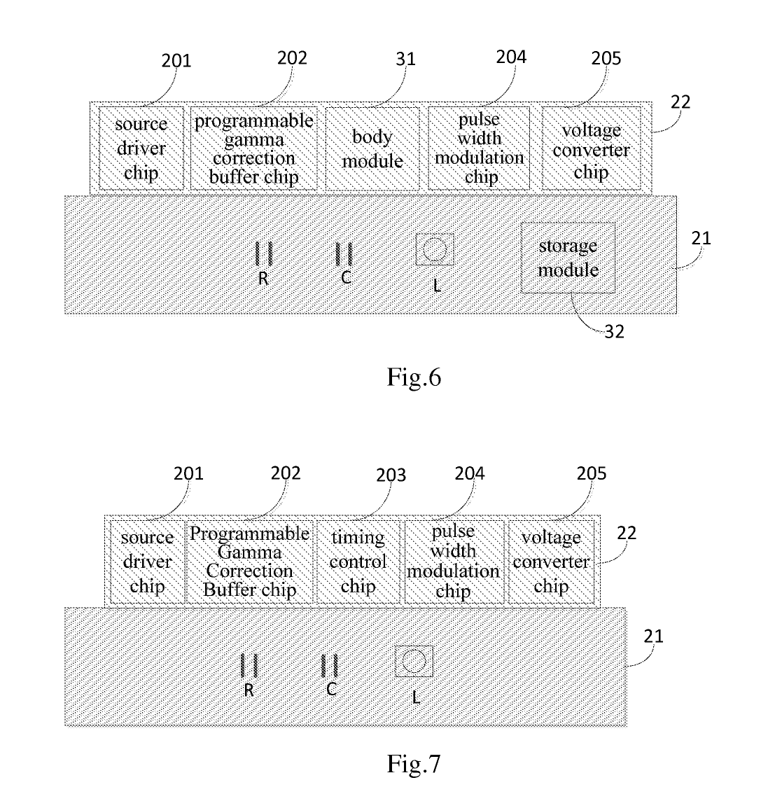

Refer to FIG. 6, which is a schematic view of a first type driving portion of the second type liquid crystal display panel according to a preferred embodiment of the present invention.

The second type liquid crystal display panel of the present invention with a driving mode of gate driver on array circuit (GOA) has a body portion and a driving portion. The body portion includes a plurality of data lines, a plurality of scan lines, and a plurality of pixel units defined by the data lines and the scan lines. Referring to FIG. 6, the driving portion includes a printed circuit board 21 and a flexible connector 22. The body portion electrically connects to the printed circuit board 21 through the flexible connector 22. The driving portion includes a plurality of chips and a plurality of electronic components. The chips comprise a source driver chip 201, a pulse width modulation chip 204, a programmable gamma correction buffer chip 202, a timing control chip 203, and a voltage converter chip 205. The voltage converter chip 205 is configured to convert a voltage of the clock signal of the timing control chip 203 for transmitting to the scan lines to drive.

The second type liquid crystal display panel is similar to the first type liquid crystal display panel with two driving modes.

Refer to FIGS. 4 and 6. The source driver chip 201, the pulse width modulation chip 204, the programmable gamma correction buffer chip 202, the voltage converter chip 205, and the body module 31 of the timing control chip 203 are disposed on the flexible connector 22, and the storage module 32 of the timing control chip 203 and the electronic components (resistors, capacitors, and inductors) are disposed on the printed circuit board 21.

The electronic components are disposed on the printed circuit board. Due to the electronic components working unstably when disposed on the flexible connector, more specifically, the inductors are disposed on the flexible connector.

The storage module is a core part of the timing control chip. Therefore the body module is disposed on the flexible connector, and the storage module is disposed on the printed circuit board. The work efficiency of the timing control chip can be ensured and more stable. In addition, all of the other chips are disposed on the flexible connector, and the size of the flexible connector cannot be increased. Thus, the size and the costs of the liquid crystal display panel can be reduced by reducing the space of the driving portion and the size of the printed circuit board.

Refer to FIG. 7, all of the timing control chip 203 is disposed on the flexible connector 22. Thus, the size of the liquid crystal display panel can be further reduced by reducing the size of the printed circuit board.

Moreover, the present invention provides a liquid crystal display device which comprises a backlight module and a liquid display panel. The liquid display panel includes a body portion and a driving portion. The body portion including a plurality of data lines, a plurality of scan lines, and a plurality of pixel units defined by the data lines and the scan lines. The driving portion includes a printed circuit board, a flexible connector, a plurality of chips, and a plurality of electronic components disposed on the printed circuit board. The body portion electrically connects to the printed circuit board through the flexible connector, and the chips comprise a source driver chip, a pulse width modulation chip, a programmable gamma correction buffer chip, and a timing control chip. The source driver chip, the pulse width modulation chip, and the programmable gamma correction buffer chip are disposed on the flexible connector to reduce a space of the driving portion.

The chips further preferably comprise a voltage converter chip, and the voltage converter chip is disposed on the flexible connector.

The timing control chip preferably has a body module and a storage module. The body module is disposed on the flexible connector, and the storage module is disposed on the printed circuit board.

The timing control chip is preferably disposed on the flexible connector.

The printed circuit board is preferably configured to provide video signals and a power source. The programmable gamma correction buffer chip is configured to modulate a pulse width of the power source from the printed circuit board. The pulse width modulation chip is configured to generate control voltage signals according the power source after modulating. The timing control chip is configured to convert the video signals to digital signals. The source driver chip is configured to generate data signals according the digital signals and the control voltage signals.

The timing control chip is preferably configured to generate clock signals, and the voltage converter chip is configured to convert a voltage of the clock signal for transmitting to the scan lines.

The size and the costs of the liquid crystal display panel of the present invention can be reduced by reconfiguring the chips and the electronic components.

The present invention has been described with a preferred embodiment thereof, and it is understood that many changes and modifications to the described embodiment can be carried out without departing from the scope and the spirit of the invention that is intended to be limited only by the appended claims.

What is claimed is:

1. A liquid crystal display panel comprising:
a body portion including a plurality of data lines, a plurality of scan lines, and a plurality of pixel units defined by the data lines and the scan lines; and
a driving portion including a printed circuit board, a flexible connector, a plurality of chips, and a plurality of electronic components disposed on the printed circuit board;
wherein the body portion electrically connects to the printed circuit board through the flexible connector, and the chips comprise:
a source driver chip;
a pulse width modulation chip;
a programmable gamma correction buffer chip;
a timing control chip for generating clock signals; and
a voltage converter chip for converting a voltage of the clock signal for transmitting to the scan lines;
wherein the source driver chip, the pulse width modulation chip, the programmable gamma correction buffer chip, and the voltage converter chip are disposed on the flexible connector to reduce a space of the driving portion.

2. The liquid crystal display panel according to claim 1, wherein the timing control chip has a body module disposed on the flexible connector, and a storage module is disposed on the printed circuit board.

3. The liquid crystal display panel according to claim 1, wherein the timing control chip is disposed on the flexible connector.

4. The liquid crystal display panel according to claim 1, wherein the printed circuit board is configured to provide video signals and a power source;
the programmable gamma correction buffer chip is configured to modulate a pulse width of the power source from the printed circuit board;
the pulse width modulation chip is configured to generate control voltage signals according the power source after modulating;
the timing control chip is configured to convert the video signals into digital signals;
the source driver chip is configured to generate data signals according the digital signals and the control voltage signals.

5. A liquid crystal display panel comprising:
a body portion including a plurality of data lines, a plurality of scan lines, and a plurality of pixel units defined by the data lines and the scan lines; and
a driving portion including a printed circuit board, a flexible connector, a plurality of chips, and a plurality of electronic components disposed on the printed circuit board;
wherein the body portion electrically connects to the printed circuit board through the flexible connector, and the chips comprise:
a source driver chip;
a pulse width modulation chip;
a programmable gamma correction buffer chip; and
a timing control chip;
wherein the source driver chip, the pulse width modulation chip, and the programmable gamma correction buffer chip, are disposed on the flexible connector to reduce a space of the driving portion.

6. The liquid crystal display panel according to claim 5, wherein the chips further comprise a voltage converter chip disposed on the flexible connector.

7. The liquid crystal display panel according to claim 5, wherein the timing control chip has a body module disposed on the flexible connector, and a storage module disposed on the printed circuit board.

8. The liquid crystal display panel according to claim 5, wherein the timing control chip is disposed on the flexible connector.

9. The liquid crystal display panel according to claim 6, wherein the printed circuit board is configured to provide video signals and a power source;
the programmable gamma correction buffer chip is configured to modulate a pulse width of the power source from the printed circuit board;
the pulse width modulation chip is configured to generate control voltage signals according the power source after modulating;
the timing control chip is configured to convert the video signals to digital signals; and
the source driver chip is configured to generate data signals according the digital signals and the control voltage signals.

10. The liquid crystal display panel according to claim 9, wherein the timing control chip is configured to generate clock signals, and the voltage converter chip is configured to convert a voltage of the clock signal for transmitting to the scan lines.

11. A liquid crystal display device comprising:
a backlight module; and
a liquid display panel comprising:
a body portion including a plurality of data lines, a plurality of scan lines, and a plurality of pixel units defined by the data lines and the scan lines; and
a driving portion including a printed circuit board, a flexible connector, a plurality of chips, and a plurality of electronic components disposed on the printed circuit board;
wherein the body portion electrically connects to the printed circuit board through the flexible connector, and the chips comprise:
a source driver chip;
a pulse width modulation chip;
a programmable gamma correction buffer chip; and
a timing control chip;
wherein, the source driver chip, the pulse width modulation chip, and the programmable gamma correction buffer chip are disposed on the flexible connector to reduce a space of the driving portion.

12. The liquid crystal display device according to claim 11, wherein the chips further comprise a voltage converter chip disposed on the flexible connector.

13. The liquid crystal display device according to claim 11, wherein the timing control chip has a body module disposed on the flexible connector, and a storage module disposed on the printed circuit board.

14. The liquid crystal display device according to claim 11, wherein the timing control chip is disposed on the flexible connector.

15. The liquid crystal display device according to claim 12, wherein the printed circuit board is configured to provide video signals and a power source;
the programmable gamma correction buffer chip is configured to modulate a pulse width of the power source from the printed circuit board;
the pulse width modulation chip is configured to generate control voltage signals according the power source after modulating;
the timing control chip is configured to convert the video signals to digital signals; and
the source driver chip is configured to generate data signals according the digital signals and the control voltage signals.

16. The liquid crystal display device according to claim 15, wherein the timing control chip is configured to generate clock signals, and the voltage converter chip is configured to convert a voltage of the clock signal for transmitting to the scan lines.
